(19) United States
(12) Patent Application Publication
(10) Pub. No.: US 2009/0046666 A1
(43) Pub. Date: Feb. 19, 2009

(54) Resource Control in a Wireless Communication Network

(75) Inventors: Rauno Huoviala, Helsinki (FI); Niclas Svahnstrom, Helsinki (FI)

Correspondence Address: COHEN, PONTANI, LIEBERMAN & PAVANE LLP, 551 FIFTH AVENUE, SUITE 1210, NEW YORK, NY, 10176, US

(73) Assignee: TeliaSonera AB, Stockholm (SE)

(21) Appl. No.: 12/087,222

(22) PCT Filed: Dec. 29, 2006
(86) PCT No.: PCT/FI2006/050592

§ 371 Date: Sep. 18, 2008

(30) Foreign Application Priority Data
Dec. 30, 2005 (FI) 20055716
Feb. 10, 2006 (FI) 20065100

(51) Int. Cl. H04B 7/216

(52) U.S. Cl. 370/335

(57) ABSTRACT

A wireless access network comprises dedicated data channels and at least one shared data channel in at least one cell. At least part of the mobile stations in the cell are capable of communicating alternatively on a dedicated data channel or a common shared data channel. A target bit rate is provided as a minimum bit rate that should be achieved in the common shared data channel by each user. If this bit rate is not achieved by a user, it is checked whether the dedicated data channel resources could offer a better bit rate level for the user. If this is the case, a dedicated data channel connection is established for the user although the user's mobile station is capable of operating in the common shared data channel.

### FIELD OF THE INVENTION

The present invention relates to digital wireless communication networks, and particularly to resource control in such networks.

### BACKGROUND OF THE INVENTION

One of the third generation mobile communication systems has been specified by 3GPP (Third generation partnership project). The first 3GPP specification was released in 1999 and is called the 3GPP release 99. The release 99 specified a third-generation (3G) mobile system comprising wideband code division multiple access (WCDMA). In the subsequent releases various new functionalities have been introduced, such as the IMS (IP multimedia subsystem). According to the release 99, the WCDMA system normally carries user data over dedicated transferred channels, DCHs, which are code multiplexed onto one RF carrier. WCDMA downlink evaluation, HSDPA (High speed downlink packet access), is part of 3GPP release 5 WCDMA specifications, which offers significantly higher data capacity and data-user speeds on the downlink compared to the release 99 system. This is possible through the use of a new transport channel type, high-speed downlink shared channel (HS-DSCH), and a set of smart mechanisms, such as very dynamic adaptive modulation and coding, a fast cellular and fast retransmissions implemented in the PTS. The new feature is fully release 99 backward compatible and can coexist on the same RF carrier as release 99 WCDMA traffic. The HSDPA feature will require new terminals which, however, will be build in with release 99 terminals and will be compatible with release 99 WCDMA networks. These terminals are referred to as HSDPA capable terminals herein.

According to the present 3GPP specifications, the HS-DSCH is shared among all HSDPA capable terminals in the cell. The HSDPA feature is designed to maximise the user bit rates, and that is the main target of the new shared channel. The HSDPA will be introduced into operator networks in stages. In the first HSDPA implementations, the code and power resources allocated to HS-DSCH are fixed, so that only part of the release 99 WCDMA resources is now dedicated to HSDPA. However, the HSDPA users can still use the release 99 WCDMA resources when operating in the DCH (dedicated channel) mode. The proportion of the fixed HSDPA resources may be 5/15 of the spreading codes, and some similar proportion of the transmission power. With these assumptions, the user bit rate achieved in HSDPA varies from below 100 kbps to 1500 kbps for a single user, depending on radio propagation. However, if resources are shared among several users, the bit rates drop linearly. Presently, admission control in a radio network controller admits all HSDPA capable terminals to the HS-DSCH, because it is expected to be more spectrum-efficient and to offer better user bit rates.

### DISCLOSURE OF THE INVENTION

An object of the present invention is to provide a new mechanism for controlling resources in a wireless data communication system having at least one common data channel shared by several users.

This object is achieved by a method, a network and a resource controller disclosed in the attached independent claims. Various embodiments of the invention are disclosed in the dependent claims.

A wireless access network comprises dedicated data channels and at least one shared data channel in at least one cell. At least part of the mobile stations in the cell are capable of communicating alternatively on a dedicated data channel and on a common shared data channel. A target bit rate (HTB) is provided as a minimum bit rate that should be achieved in the common shared data channel by each user. If this bit rate is not achieved by a user, it is checked whether the dedicated data channel resources could offer a better bit rate level for the user. If this is the case, a dedicated data channel connection is established for the user although the user's mobile station is capable of operating in the common shared data channel. As a result, the achieved user bit rate will not drop to a very low level as may occur if all terminals capable of using the shared data channel are admitted to limited common shared data channel resources in the cell. The invention enables to detect the low user bit rate levels in the common shared data channel and to determine whether the dedicated data channel resources would be less congested and would actually offer better user bit rates than the common shared data channel resources.

In an embodiment of the invention, it is periodically checked whether the common shared data channel resources have again increased to the level where they can offer the target bit rate for the user with current radio conditions. If the target bit rate can be achieved according to this check, the user is allocated to the common shared data channel. This control helps to avoid over-loading of the dedicated data channel resources, to prefer the common shared data channel due to its better spectrum efficiency, and to prefer the common shared data channel resources for non-real-time-users.

In a further embodiment of the invention, it is also periodically checked whether the user bit rate in the dedicated data channel is downgraded to below the target bit rate. If the user bit rate is below the target bit rate in the dedicated data channel, the user is allocated to the common shared data channel resources.

In further embodiments, the supporting parameters may be added to the admission control, such as threshold timers or other kind of hysteresis to avoid ping pong between the dedicated data channel and the common shared data channel resources.

An embodiment of the invention comprises establishing a connection in or changing a connection to a dedicated data channel only if the bit rate offered by the dedicated data channel is higher than the bit rate offered by the common shared data channel plus a first predetermined offset.

A further embodiment of the invention comprises, for a user currently operating on a dedicated data channel, periodically checking whether the bit rate offered by the common shared data channel is higher than the bit rate offered by the dedicated data channel plus a second predetermined offset, preferably for a predetermined third period of time, and if the checking is positive, changing a connection of the user to said at least one common shared data channel, or if the checking is negative, maintaining a connection of the user on the dedicated data channel.

A further embodiment of the invention comprises, for a user currently operating on a common shared data channel but, periodically checking whether the bit rate offered by the dedicated data channel is higher than the bit rate offered by the common shared data channel plus a first predetermined offset, preferably for a predetermined second period of time, and if the checking is positive, changing a connection of the user to said dedicated data channel, or if the checking is negative, maintaining a connection of the user on the common shared data channel.

A further embodiment of the invention comprises applying the target bit rate for controlling channel resources only for predetermined network services and controlling the remaining network services selectively to always use either a common shared data channel or a dedicated data channel.

### BRIEF DESCRIPTION OF THE DRAWINGS

A detailed description of example embodiments of the present invention will be made below with reference to the attached drawings, in which

FIG. 1 is a schematic diagram showing an example of a wireless radio system in which the present invention can be applied;

FIG. 2 is a schematic diagram illustrating the concept of dedicated channel and a common shared channel in the wireless radio system shown in FIG. 1; and

FIGS. 3, 4, 5 and 6 are flow diagrams illustrating examples of a resource control approach according to the present invention:

### A DETAILED DESCRIPTION OF EXEMPLARY EMBODIMENTS OF THE INVENTION

The exemplary embodiments of the present invention will be described as embodied in a UMTS system, more particularly in a wide band CDMA (WCDMA) radio access network. The invention is not, however, intended to be restricted to the specific radio system described but the principles of the present invention can be applied to any wireless radio access network having dedicated data channels and at least one common shared data channel, in downlink and/or uplink.

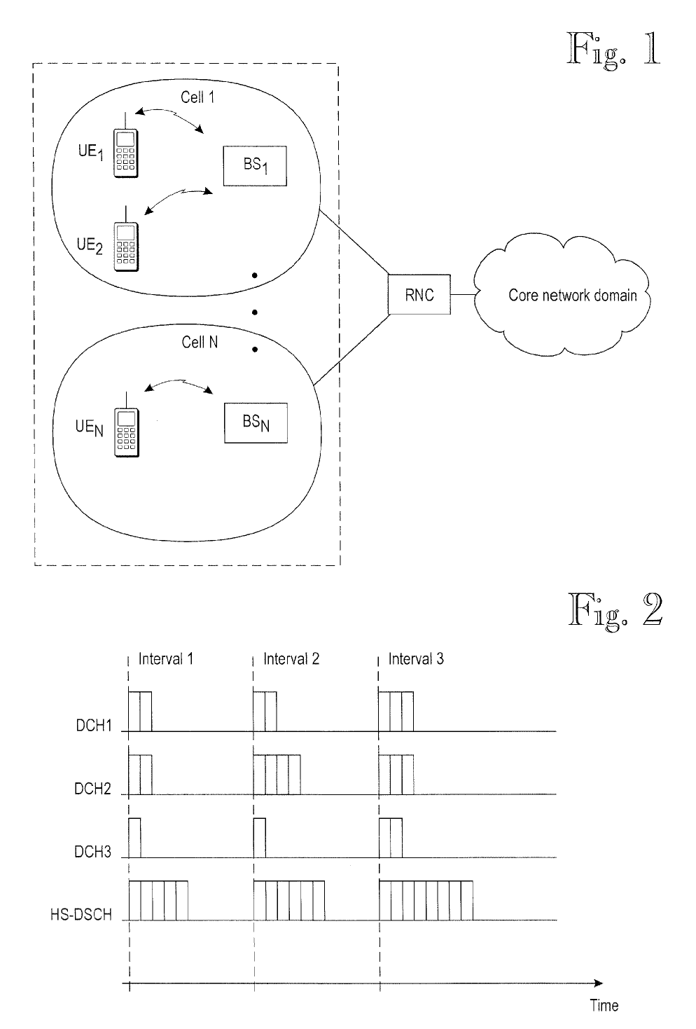

FIG. 1 illustrates a basic architecture of UMTS radio access network (UTRAN). The main task of UTRAN is to create and maintain radio access bearers (RAB) for communication between user equipment (UE) and the core network CN. UTRAN consists of radio network sub-systems RNS and each RNS contains various number of radio elements, i.e. base stations BS, also referred to as node B, and one controlling element, e.g. radio network controller RNC. In WCDMA technology, all users share the common physical resource, the frequency band. All users of the WCDMA are present on the frequency band at the same moment of time, and defined transactions are recognized with spreading codes. The WCDMA radio access allocates bandwidth for users and the allocated bandwidth and its controlling functions are handled with the term “channel”. The functionality implemented through the WCDMA defines what kind of channels are required and how they are organized. The channel organization the WCDMA uses is a tree-layer one; the logical channels, transport channels and physical channels. From these, the logical channels describe the types of information to be transmitted; transport channels describe how the logical channels are to be transferred; and the physical channels are the “transmission media” providing the radio platform through which the information is equally transferred. The base station BS implements WCDMA radio access physical channels and transfers information from trans-port channels to the physical channels based on the arrangement determined by the radio network controller RNC. The RNC is the switching and controlling element of the UTRAN which is also responsible for efficient sharing and managing of the radio resources. Instead of physical channels, the RNC “sees” the transport channels.

The WCDMA system normally carries user data over dedicated transport channels, DCHs, which are code multiplexed onto one RF carrier. HSDPA (High Speed Downlink Packet Access) introduces a new transport channel type, high speed downlink shared channel (HS-DSCH) which shares multiple access codes, transmission power and use of infrastructure hardware between several users.

FIG. 2 shows a simplified explanation of the principle of sharing a common transport channel. Channels DCH1, DCH2 and DCH3 represent dedicated transport channels according to release 99 WCDMA, each dedicated channel being assigned to one user or mobile equipment UE. The shadowed columns in FIG. 2 represent traffic in each dedicated channel over time. As can be seen, the traffic on the dedicated transport channel DCH varies greatly over time (due to the bursty packet data). As a result, the bandwidth is wasted during the non-traffic (silent) periods, and the usage of radio resources is inefficient. On the other hand, the common shared transport channels HS-DSCH shown at the bottom of FIG. 2 can carry all the packet data of the dedicated channels DCH1, DCH2, DCH3, and thereby the radio network resources can be used efficiently to serve a large number of users accessing bursty data. When one user has sent a data packet over the network, another user then gains access to the resources and so forth. In other words, several users can be time multiplexed so that during silent periods, the resources are available to other users.

As noted above, presently the admission control in the RNC admits all HSDPA capable terminals to a common shared channel, HS-DSCH, just because it is in theory more spectrum efficient. It has been expected that HSDPA always offers better user bit rates, and therefore it is preferred. However, in the first HSDPA implementations, the radio resources (e.g. code and power resources) allocated to the HS-DSCH channel resources are fixed, so that only part of the release 99 WCDMA resources may be dedicated to the HSDPA. However, the HSDPA users can still use the release 99 WCDMA resources when operating in a DCH (dedicated channel) mode. The fixed HSDPA resources may be in proportion 5/15 of spreading codes, and some similar proportion of the transmission power. With these assumptions, the user bit rate achieved in the HSDPA varies from under 100 kbps to 1500 kbps for a single user, depending on radio propagation. However, if the resources are shared among several users, the bit rates drop linearly. Therefore, with such limited and fixed HSDPA resources, the result of this may be that, with several HSDPA users in a cell, the achieved user bit rate may drop to a very low level. At the same time, the release 99 resources may not be so congested and would actually offer much better user bit rates.

Therefore, in accordance with the principles of the present invention, a resource controller in a radio access network, such as the RNC in the WCDMA network, is arranged to control the loading of a common shared data channel in the cell so that the user experiences sufficient bit rates, by offering the dedicated data channel resources if they can provide better throughput at a specific moment of time.

According to an embodiment of the invention, a target bit rate is set to the common shared data channel. In the HSDPA environment described above, the target bit rate is called a HSDPA target bit rate (HTB). The target bit rate HTB may represent a minimum user bit rate that should be achieved in the HS-DSCH.

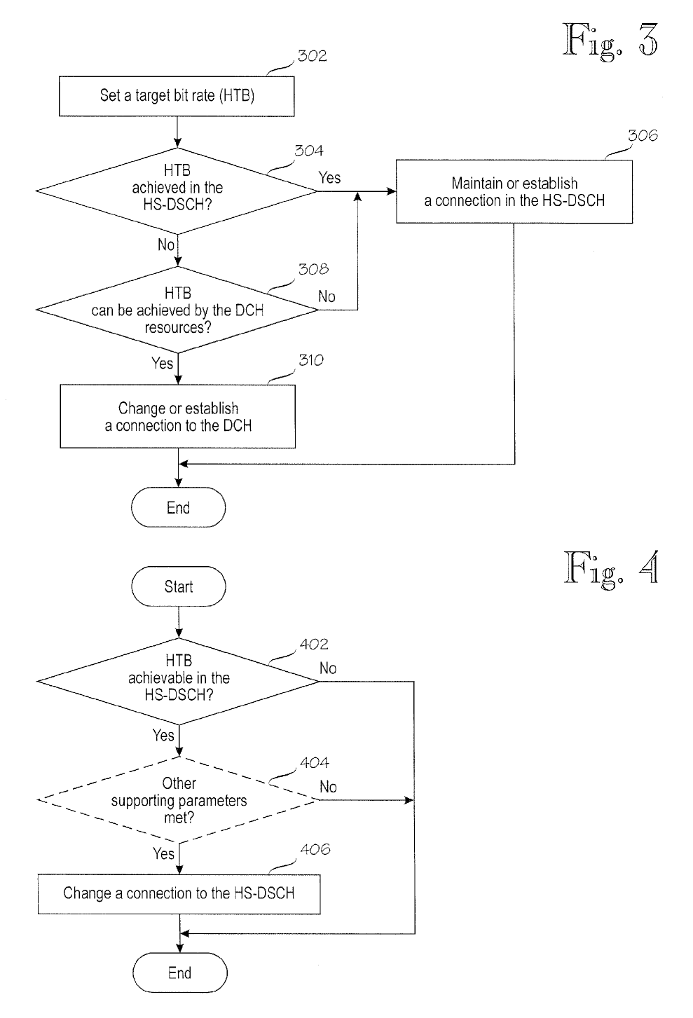

FIG. 3 is a flow diagram illustrating an example of an admission control algorithm according to the present invention. The algorithm may be embodied in any radio resource control unit, such as a radio network controller RNC, in a radio access network. Firstly, a network operator or another network administrator sets an HSDPA target bit rate or a specific shared common channel HS-DSCH in a cell, step 302. When HSDPA capable user equipment requests access to the HS-DSCH, the RNC checks whether a minimum bit rate defined by the target bit rate can be achieved for the user equipment if access to the HS-DSCH is admitted, step 304. Alternatively, or in addition, the RNC may perform the check in step 304 also for the ones of user equipment already admitted to the HS-DSCH. If the HTB is achieved for the user equipment in the HS-DSCH, the RNC admits access to the HS-DSCH (e.g. establishes a connection in the HS-DSCH), or maintains the existing connection in the HS-DSCH, step 306. However, if the target bit rate HTB is not achieved for the user equipment in the HS-DSCH, the RNC checks whether the dedicated channel (DCH) resources could offer at least the HTB level, step 308. If the HTB level cannot be offered by the DCH resources, the algorithm proceeds to step 306. However, if the HTB level can be achieved by the DCH resources, the RNC allocates appropriate DCH resources for the user equipment, and establishes or switches the connection to the allocated DCH resources, step 310.

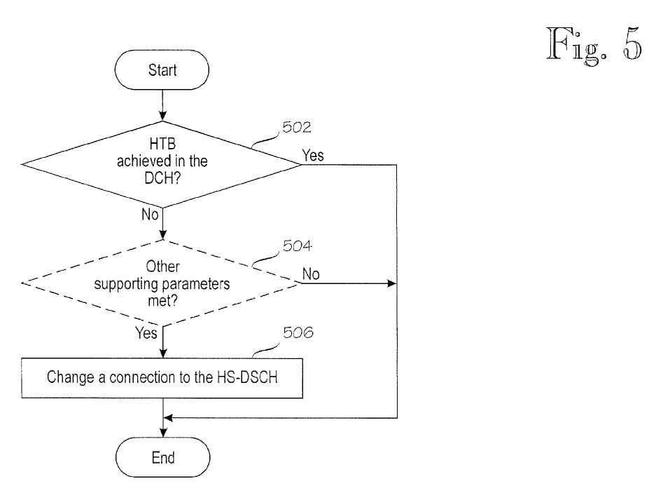

In an embodiment of the invention, illustrated in FIG. 4, the RNC periodically checks if the HSDPA resources (e.g. codes, power) have increased to the level where they can offer the HTB to HSDPA capable user equipment currently using DCH resources, step 402. If according to this check, the HTB can be achieved in the HS-DSCH, the HSDPA capable user equipment is allocated (back) to the HS-DSCH, step 406. This further control may be required in order to avoid the DCH resource overloading, to prefer HSDPA for non-real-time users, and to prefer the HSDPA due to its better spectrum efficiency. The checking interval may be determined with the parameter P1 described below, for example.

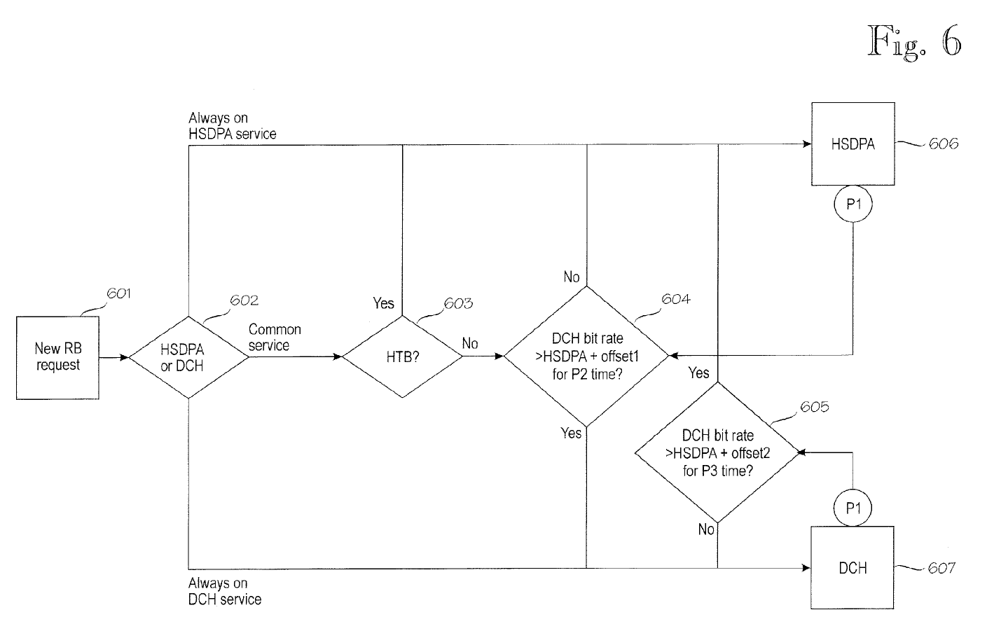

In a further embodiment of the invention, illustrated in FIG. 5, the RNC may further check if the DCH radio bearer has downgraded to a level which provides a user bit rate below the HTB, step 502. If the HTB level is not achieved in the DCH, the connection is changed to the common shared channel, HS-DSCH, step 506. The checking interval can be determined with the parameter P1 described below, for example.

In the embodiments shown in FIGS. 4 and 5, also other supporting parameters may be checked in the RNC, steps 404 and 506, in order to avoid a ping-pong effect between the dedicated channel CDH and the common shared channel HS-DSCH. Examples of such parameters include threshold timers, offsets and other mechanisms introducing hysteresis to the resource control according to the present invention, such as parameters shown in Table 1 below. If the supporting parameters are not met in step 404 or 504, the step 406 or 506 is not performed but the existing channel allocation is maintained.

In a further embodiment of the invention, the RNC may check for HSDPA capable user equipment currently using a DCH, if the HS-DSCH radio bearer can offer a better user bit rate than the DCH. If no better bit rate is offered in the HS-DSCH, the connection is maintained on the DCH. If a better bit rate is offered in the HS-DSCH, the connection is changed to HS-DSCH. The checking interval can be determined with the parameter P1 described below, for example.

In a further embodiment of the invention, the RNC may check for HSDPA capable user equipment currently using a HS-DSCH, if the DCH radio bearer can offer a better user bit rate than the HS-DSCH. If no better bit rate is offered in the HS-DSCH, the connection is maintained on the HS-DSCH. If a better bit rate is offered in the DCH, the connection is changed to DCH. The checking interval can be determined with the parameter P1 described below, for example.

In a further embodiment of the invention, the PNC may judge, based on the type of a requested service, a traffic class, or other criterion, whether user equipment is allocated an “Always on HSDPA” service, an “Always on DCH” service, or a common service using alternately both HSDPA and DCH as described above.

An example parameter configuration is shown in Table 1:

| | Service | Target | | | | Bit rate | Bit rate |
|---|---|---|---|---|---|---|---|
| | type | Rate(HT) | P1 | P2 | P3 | offset | offset |
| Backgroun | HSDP | — | — | — | — | — | — |
| Interactiv | Commo | 384 | 5 s | 10 s | 5 s | 20 | 10 |
| THP= | | | | | | | |
| Interactiv | Commo | 128 | 5 s | 10 s | 5 s | 50 | 10 |
| THP= | | | | | | | |
| Interactiv | Commo | 128 | 5 s | 10 s | 5 s | 50 | 10 |
| THP= | | | | | | | |
| Streamin | Commo | 128 | 5 s | 5 s | 10 s | 10 | 20 |
| Conversation | DCH | — | — | — | — | — | — |

Description of the Parameters:

HTB: Target minimum bit rate in the HSDPA user plane (HS-DSCH channel) for a radio bearer.

P1: Time that must be waited before radio resource management (RRM) measurements for re-allocation (between HSDPA and DCH) can be started.

P2: Time during which the offset1 must be valid before the change from HSDPA to DCH can be made. This introduces hysteresis into the allocation process.

P3: Time during which the offset2 must be valid before the change from DCH to HSDPA can be made. This introduces hysteresis into the allocation process.

Offset1: The amount of estimated excessive user bit rate in DCH as compared with HSDPA, that must be achievable before change from HSDPA to DCH can be made. This introduces hysteresis into the allocation process.

Offset2: The amount of estimated excessive user bit rate in HSDPA as compared with DCH, that must be achievable before change from DCH to HSDPA can be made. This introduces hysteresis into the allocation process.

A further embodiment of the invention which includes features from many of the above embodiments and utilizes the parameters in Table 1 will now be described with reference to FIG. 6.

In step 601, HSDPA capable user equipment sends RNC a new access request, e.g. radio bearer request access including information about at least one of traffic class (TC), THP (Traffic Handling Priority), and ARP (Allocation and Retention Priority).

In step 602, the radio resource management (RRM) in the RNC uses Table 1 to execute the allocation procedure according to TC, THP, or ARP received in the request.

Services (such as “Background” in Table 1) that the operator has decided to be “always on HSDPA” are allocated to the HSDPA with no further actions (i.e. using the conventional allocation mechanisms), and the allocation process proceeds to step 606.

Similarly “always on DCH” services (such as “Conversational” in Table 1) are allocated to DCH with no further actions and the process proceeds to step 607.

Services that the operator has parameterised to be accessible in both HSDPA and DCH will proceed to step 603 and go through a further analysis using the HSDPA target bit rate (HTB), P1, P2 and bit rate offset parameters.

In step 603, the RRM measures the achievable resources and the corresponding achievable bit rate for the radio bearer RB in HSDPA. If the HTB of the TC/THP/ARP can be achieved, HSDPA is allocated and the process proceeds to step 606.

If the HTB cannot be achieved according to the check in step 603, the RRM measures if DCH can offer a higher bit rate (measured HSDPA bit rate+offset1) in step 604. If it can, DCH is allocated and the process proceeds to step 607. If it cannot, HSDPA is allocated and the process proceeds to step 606. P2 timer may not be used in the initial allocation to avoid delaying RB establishment.

If the user is in HSDPA in step 606, after the time P1 from the allocation has expired, the RRM continuously measures the same analysis as in step 604 but uses P2 as a pending time for triggering the change from HSDPA to DCH.

If the user is in DCH in step 607, after the time P1 from the allocation has expired, the RRM continuously measures if HSDPA can offer a higher bit rate (measured DCH bit rate+offset2) in step 605, and uses the time P3 as a pending time for triggering change from DCH to HDSPA.

The foregoing detailed description shows only certain exemplary embodiments of the present invention. However, those skilled in the art will recognize that many modifications and variations may be made without departing substantially from the spirit and scope of the present invention as discussed and illustrated herein. Accordingly, it should be clearly understood that the form of the invention described herein is exemplary only and is not intended to limit, in any way, the scope of the invention as defined in the following claims.

1. A method of controlling channel resources in a wireless communication network having dedicated data channel resources and at least one common shared data channel, comprising
a) setting a target bit rate for said at least one common shared data channel,
b) for a user capable of using said at least one common shared data channel, checking whether at least said target bit rate can be offered to the user in said at least one common shared data channel, and
c) if at least said target bit rate can be offered to the user in said at least one common shared data channel, establishing or maintaining a connection in said at least one common shared data channel, or
d) if at least said target bit rate cannot be offered to the user in said at least one common shared data channel, checking whether a connection can be established in or changed to a dedicated data channel.

2. A method according to claim 1, further comprising,
for a user capable of using said at least one common shared data channel but currently operating on a dedicated data channel, periodically checking whether at least said target bit rate becomes available to the user in said at least one common shared data channel, and
if at least said target bit rate can be offered to the user in said at least one common shared data channel, changing a connection of the user to said at least one common shared data channel.

3. A method according to claim 1, comprising,
for a user capable of using said at least one common shared data channel but currently operating on a dedicated data channel, periodically checking whether the achieved user bit rate has dropped below the target bit rate in the dedicated data channel, and
if the achieved user bit rate has dropped below the target bit rate in the dedicated data channel, changing a connection of the user to said at least one common shared data channel.

4. A method according to claim 2, comprising
changing a connection of the user to said at least one common shared data channel only if at least one further parameter is met, so as to introduce hysteresis into the changing between the dedicated data channel and the common shared data channel.

5. A method according to claim 1, comprising
said step d) comprising establishing a connection in or changing a connection to a dedicated data channel only if the bit rate offered by the dedicated data channel is higher than the bit rate offered by the common shared data channel plus a first predetermined offset.

6. A method according to claim 1, further comprising,
for a user currently operating on a dedicated data channel, after a first predetermined period of time has expired from the allocation, periodically checking whether the bit rate offered by the common shared data channel is higher than the bit rate offered by the dedicated data channel plus a second predetermined offset, preferably for a predetermined third period of time, and
if the checking is positive, changing a connection of the user to said at least one common shared data channel, and
if the checking is negative, maintaining a connection of the user on the dedicated data channel.

7. A method according to claim 1, further comprising
for a user currently operating on a common shared data channel but, after a predetermined period of time has expired from the allocation, periodically checking whether the bit rate offered by the dedicated data channel is higher than the bit rate offered by the common shared data channel plus a first predetermined offset, preferably for a predetermined second period of time, and
if the checking is positive, changing a connection of the user to said dedicated data channel, and
if the checking is negative, maintaining a connection of the user on the common shared data channel.

8. A method according to claim 1, further comprising
applying the target bit rate for controlling channel resources only for predetermined network services and controlling the remaining network services selectively to always use either a common shared data channel or a dedicated data channel.

9. A wireless access network comprising dedicated data channel resources and at least one common shared data channel, comprising
means for setting a target bit rate for said at least one common shared data channel,
means for checking whether at least said target bit rate can be offered in said at least one common shared data channel to user equipment capable of using said at least one common shared data channel,
means for establishing or maintaining a connection in said at least one common shared data channel, if at least said target bit rate can be offered to the user in said at least one common shared data channel, and
means for establishing a connection in or changing a connection to a dedicated data channel, if at least said target bit rate cannot be offered to that user in said at least one common shared data channel and said dedicated data channel provides an appropriate bit rate.

10. A wireless access network according to claim 9, further comprising
means periodically checking whether at least said target bit rate becomes available to the user in said at least one common shared data channel, when the user is capable of using said at least one common shared data channel but currently operating on a dedicated data channel, and
means for changing a connection of the user to said at least one common shared data channel if at least said target bit rate can be offered to the user in said at least one common shared data channel.

11. A wireless access network according to claim 9, further comprising
means for periodically checking whether the achieved user bit rate has dropped below the target bit rate in the dedicated data channel, when the user is capable of using said at least one common shared data channel but currently operating on a dedicated data channel, and
means for changing a connection of the user to said at least one common shared data channel if the achieved user bit rate has dropped below the target bit rate in the dedicated data channel.

12. A wireless access network according to claim 9, further comprising
means for changing a connection of the user to said at least one common shared data channel only if at least one further parameter is met, so as to introduce hysteresis into the changing between the dedicated data channel and the common shared data channel.

13. A wireless access network according to claim 9, comprising
means for establishing a connection in or changing a connection to a dedicated data channel only if the bit rate offered by the dedicated data channel is higher than the bit rate offered by the common shared data channel plus a first predetermined offset.

14. A wireless access network according to claim 9, comprising
means responsive to a user currently operating on a dedicated data channel, after a first predetermined period of time has expired from the allocation, for periodically checking whether the bit rate offered by the common shared data channel is higher than the bit rate offered by the dedicated data channel plus a second predetermined offset, preferably for a predetermined third period of time,
means responsive to a positive result of the checking, for changing a connection of the user to said at least one common shared data channel,
means responsive to a negative result of the checking, for maintaining a connection of the user on the dedicated data channel.

15. A wireless access network according to claim 9, comprising
means responsive to a user currently operating on a common shared data channel, after a predetermined period of time has expired from the allocation, for periodically checking whether the bit rate offered by the dedicated data channel is higher than the bit rate offered by the common shared data channel plus a first predetermined offset, preferably for a predetermined second period of time,
means responsive to a positive result of the checking, for changing a connection of the user to said dedicated data channel,
means responsive to a negative result of the checking, for maintaining a connection of the user on the common shared data channel.

16. A wireless access network according to claim 9, comprising
means for applying the target bit rate to controlling channel resources only for predetermined network services and controlling the remaining network services selectively to always use either a common shared data channel or a dedicated data channel.

17. A resource controller for a wireless access network comprising dedicated data channel resources and at least one common shared data channel, the controller comprising
means for setting a target bit rate for said at least one common shared data channel,
means for checking whether at least said target bit rate can be offered in said at least one common shared data channel to user equipment capable of using said at least one common shared data channel,
means for establishing or maintaining a connection in said at least one common shared data channel, if at least said target bit rate can be offered to the user in said at least one common shared data channel, and
means for establishing a connection in or changing a connection to a dedicated data channel, if at least said target bit rate cannot be offered to the user in said at least one common shared data channel and said dedicated data channel provides an appropriate bit rate.
